(19) United States
(12) Patent Application Publication
(10) Pub. No.: US 2003/0179586 A1
(43) Pub. Date: Sep. 25, 2003

(54) Color-changeable vehicle frog lamp

(76) Inventor: Chi-Shiang Pan, Taipei (TW)

Correspondence Address: Chi-Shiang Pan, 235 Chung-Ho, Box 8-24, Taipei, TW

(21) Appl. No.: 10/100,296

(22) Filed: Mar. 19, 2002

(51) Int. Cl. F21V 21/00

(52) U.S. Cl. 362/545; 362/464; 362/231; 362/800

(57) ABSTRACT

A color-changeable vehicle fog lamp includes a U-like shape circuit board. Each of the three surfaces of the circuit board is arranged with a plurality of light emitting diodes which may present various colors. The circuit board is placed in a light mask and then the light mask is placed in a fog lamp. Each of the light emitting diode on the circuit board is connected to a control circuit. By a preinstalled program in the control circuit, different light emitting diode can be lighted up so as to present various colors. Thereby, the fog lamp can present a different color according to the conditions of the road, whether, requirements of the driver, etc.

### FIELD OF THE INVENTION

The present invention relates to fog lamps, and particularly to a color-changeable vehicle frog lamp which can present a different color according to the conditions of the road, whether, requirements of the driver, etc.

### BACKGROUND OF THE INVENTION

Referring to FIG. 1, a prior fog lamp installed in a lower edge of a vehicle is illustrated. In the prior art, a lamp casing 10 has a light mask 11. A general bulb 12 is placed in the light mask 11. A surface of the lamp casing 11 is covered by a yellow transparent glass mask 13 so as to form a fog lamp 1. After the bulb 12 lights up, by the yellow transparent glass mask 13, a yellow light is presented. Thereby, in a condition of dense fog, the driver can see the road by the illumination of the fog lamp. However, in general, the fog lamp only presents one color (since it is only used in the fog). In another prior art, an annular lamp mask 14 is added around the periphery of the fog lamp 1 as a decoration, while it has no practical benefit to the driver.

### SUMMARY OF THE INVENTION

Accordingly, the primary object of the present invention is to provide a color-changeable vehicle fog lamp which can present a different color according to the conditions of the road, whether, requirements of the driver, etc.

To achieve the object, the present invention presents a color-changeable vehicle frog lamp, wherein color-changeable vehicle fog lamp includes a U-like shape circuit board. Each of the three surfaces of the circuit board is arranged with plurality of emitting diodes which may present various colors. The circuit board is placed in a light mask and then the light mask is placed in a fog lamp. By lighting up light emitting diodes of different colors, the fog lamp can present a different color according to the conditions of the road, whether, requirements of the driver, etc.

In above mentioned structure, Each of the light emitting diode on the circuit board is connected to a control circuit. By a preinstalled program in the control circuit, different light emitting diode can be lighted up so as to present various colors.

The various objects and advantages of the present invention will be more readily understood from the following detailed description when read in conjunction with the appended drawing.

### BRIEF DESCRIPTION OF THE DRAWINGS

FIG. 1 is a schematic view showing a prior art fog lamp.

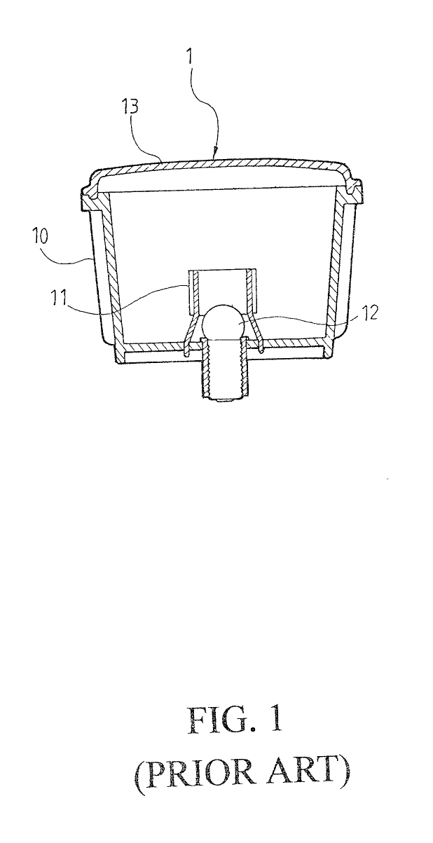

FIG. 2 is an exploded perspective view of the prior fog lamp illustrated in FIG. 1.

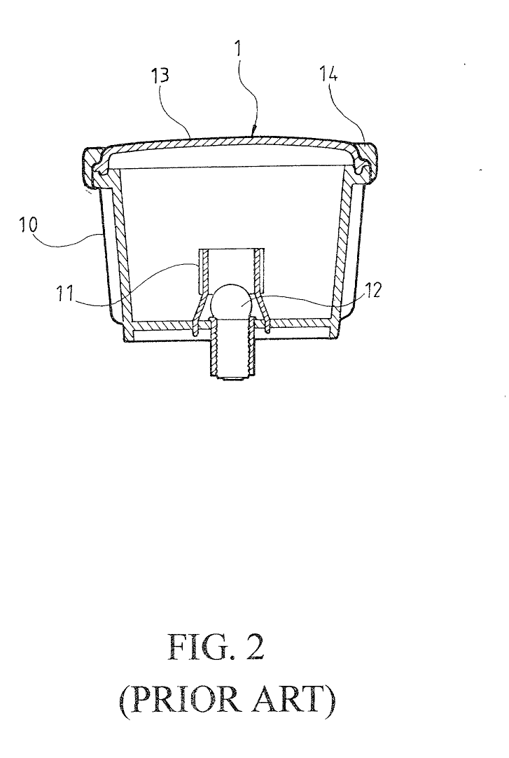

FIG. 3 is an exploded schematic view of the present invention.

FIG. 4 is a cross sectional view of the present invention.

FIG. 5 is a block diagram showing one preferred embodiment of the present invention.

FIG. 6 is a schematic view showing that the present invention is used in a car.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

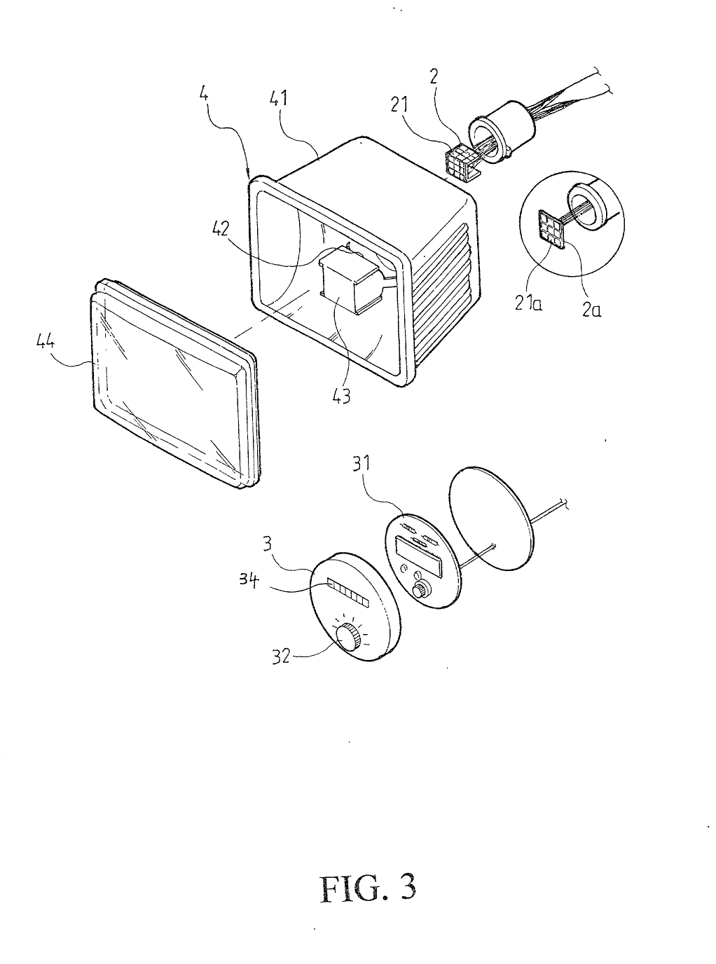

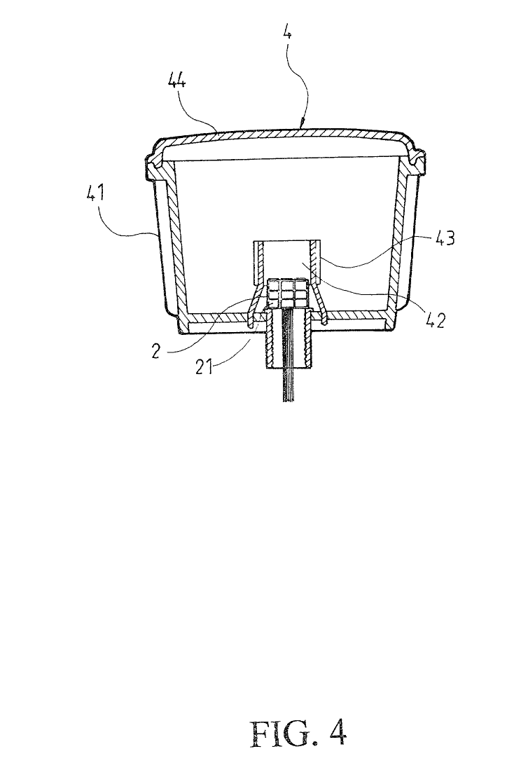

Referring to FIGS. 3 and 4, the color-changeable vehicle fog lamp of the present invention is illustrated. The present invention includes a U-like shape circuit board 2 (or a single-face circuit board 2a). Each of the three surfaces of the circuit board 2 are arranged with at least one light emitting diode 21 with may present various colors. Each light emitting diode 21 is connected to a control circuit 31. The control circuit 31 is placed in a control box 3. The control box 3 has a key 32 for controlling the lightening and colors of the light emitting diodes 21. The control box 3 has a window 34. The window 34 has a light emitting diode which is operated synchronously with the light emitting diode 21 and presents the same color as the light emitting diode 21. Thereby, the user may know the color of the light emitting diode 21 and adjust the color.

The present invention further comprises a fog lamp 4 which has a lamp casing 41 made of metal or other materials so that the inner side of the lamp casing 41 is reflective. A center of the lamp casing 41 is installed with a receiving chamber 42 for placing the circuit board 2. A light mask 43 is installed in front of the receiving chamber 42. A surface of the lamp casing 41 is installed with a transparent glass mask 44.

The fog lamp 4 formed by above mentioned components can be installed at a front lower edge of a vehicle. Thereby, a light emitting diode 21 lighted up by the control circuit 31 present various colors. As a consequent, the light mask 43 and the transparent glass mask 44, the fog lamp 4 presents various colors.

The light color of the fog lamp can be changed according to the conditions of the road and whether. For example, a yellow color is used as driving in fog and white color is used as driving in a mountain.

The fog lamp 4 can be used as an alarm light by a special light, for example, red light.

The fog lamp 4 can be used as an indicator when the driver overtakes a car.

The color of the fog lamp 4 can be changed as desired so as to present a decorating effect.

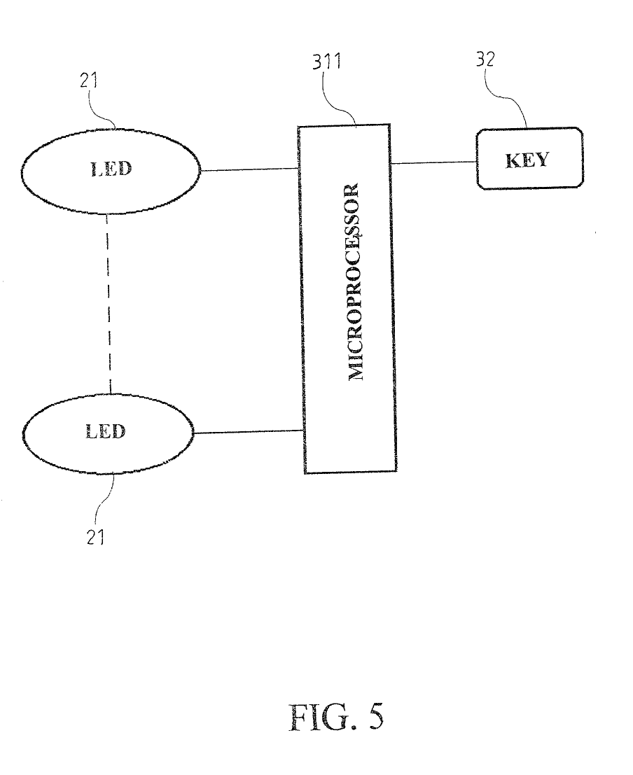

Referring to FIG. 5, the control circuit 31 of the present invention has a microprocessor 311. The output end of the microprocessor 311 is connected to various light emitting diodes 21 and the input end thereof is connected to the key 32. The microprocessor 311 is installed with a driving program. When the key 32 is pressed, the light emitting diode 21 can be lighted up so that the light emitting diode 21 presents a different color.

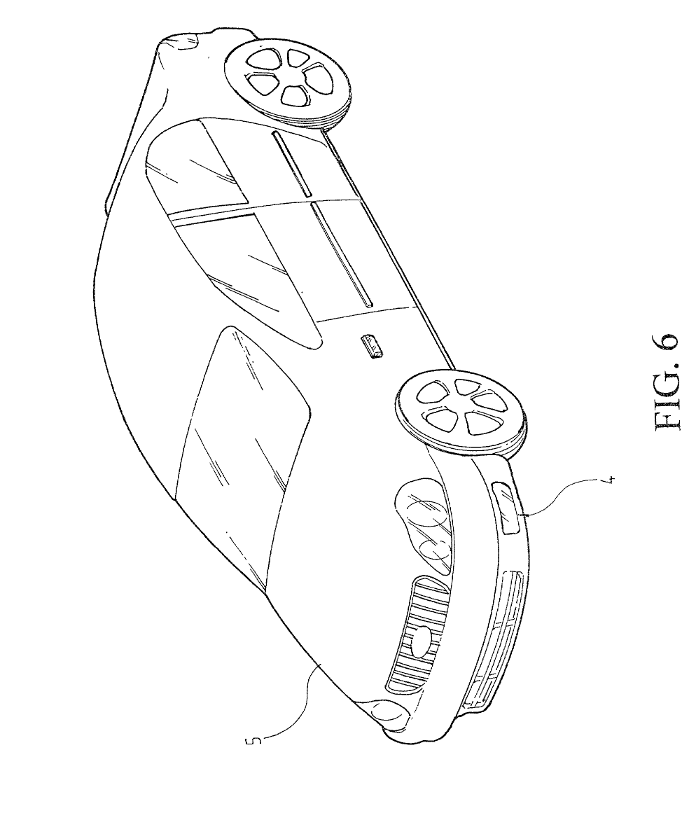

Referring to FIG. 6, after the present invention is assembled, it can be assembled as a fog lamp 4 of a vehicle so as to emit different color to be used in different condition.

In summary, in the present invention, by the light emitting diodes and a control program, the fog lamp of a vehicle can emit light of different color so as to improve the use of fog lamps.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A color-changeable vehicle frog lamp comprising;
a fog lamp having a lamp casing, a receiving chamber being installed in a center of the lamp casing; a front end of the receiving chamber having a light mask; and
a control circuit having a microprocessor with a predetermined program therein; the microprocessor being connected to a control circuit; a plurality of light emitting diodes emitting lights of different colors being arranged on the circuit board; the circuit board being installed in the receiving chamber of the lamp casing;
wherein by above mentioned components, the light emitting diode installed on the circuit board is driven and lights up by the program in the microprocessor of the control circuit so as to present various colors, thereby, the fog lamp can present various colors according to different conditions.
